(19) United States
(12) Patent Application Publication
(10) Pub. No.: US 2010/0121739 A1
(43) Pub. Date: May 13, 2010

(54) ON-LINE GROUP DESIGN AND PURCHASING OF CUSTOMIZED MERCHANDISE

(75) Inventor: Justin Allan McCarthy, San Mateo, CA (US)

Correspondence Address: PILLSBURY WINTHROP SHAW PITTMAN LLP, P.O. BOX 10500, MCLEAN, VA, 22102, US

(73) Assignee: CAFEPRESS.COM, SAN MATEO, CA (US)

(21) Appl. No.: 12/606,049

(22) Filed: Oct. 26, 2009

Related U.S. Application Data
(60) Provisional application No. 61/108,160, filed on Oct. 24, 2008.

(51) Int. Cl. G06Q 30/00; G06Q 20/00; G06Q 99/00

(52) U.S. Cl. 705/27; 705/319

(57) ABSTRACT

The present invention provides an online platform for organizations to design and create customized merchandise and to offer the merchandise for sale to their members and to the general public. The organization sets up an online group account to facilitate the design and sale of a customized product. The platform allows the organization to create customized merchandise by designing products for its members or by defining parameters that enable its members or other individuals to customize certain aspects of merchandise, and also to provide a private or public forum for members to submit, share and vote on designs and otherwise interact with each other. The platform provides various forms of payment to accommodate different purchasers and to account for any sponsors or donors.

### RELATED APPLICATION

This application claims priority to U.S. Provisional Patent Application Ser. No. 61/108,160 filed Oct. 24, 2008.

### FIELD OF THE INVENTION

The present invention relates generally to methods of designing, offering for sale and distributing customized merchandise for groups such as teams or other organizations. More particularly, it relates to an online platform that allows an organization to create and design a customized product and then merchandise it to its members.

### SUMMARY OF THE INVENTION

Briefly, a preferred embodiment of the present invention includes a method using an online platform to provide organizations with the ability to design and create customized merchandise and to offer the merchandise for sale to their members and if desired also to the general public. The platform allows the organization to set up an online group account with a unique account identification to facilitate the design and sale of a customized product. The platform allows the organization to create customized merchandise by designing products for its members to purchase or by defining parameters that enable its members or other individuals to customize certain aspects of selected base merchandise, and also to provide a private or public forum for members to submit, share and vote on designs and otherwise interact with each other. The group account may be accessible to a limited or unlimited number of members as the organization desires, and the products may be sold in a public or private online marketplace. The platform provides various forms of payment to accommodate different purchasers and to account for any sponsors or donors. For example, the platform allows groups to manage and collect their payments more easily by facilitating purchasers' payments whether in full or in installments, aggregating the purchasers' payments for the group organizer, processing any donations directly through the group account, and permitting any sponsors to apply funds toward group purchases. The platform allows an organization's members and other individuals to set up individual online accounts with unique account identification that permits an individual to log-in to his or her account, to access and browse various groups, forums and use various features, to contribute to product design by voting on designs, by proposing new designs (including creating new designs using various product design applications), or by interacting with other individuals including group members regarding the products within various forums, to purchase products in various sizes and quantities (including group purchases), to specify various payment and delivery preferences, and to monitor order status or view recent purchases.

### IN THE DRAWING

FIG. 1 is an example of the group purchase functionality within the group account interface of the present invention.

FIG. 2 shows various functionalities within the individual account interface of the present invention.

FIG. 3 is an example of the product designer functionality within the individual account interface of the present invention.

FIG. 4 is an example of the sharing and voting functionalities within an individual account interface of the present invention from the perspective of an individual user.

### DETAILED DESCRIPTION

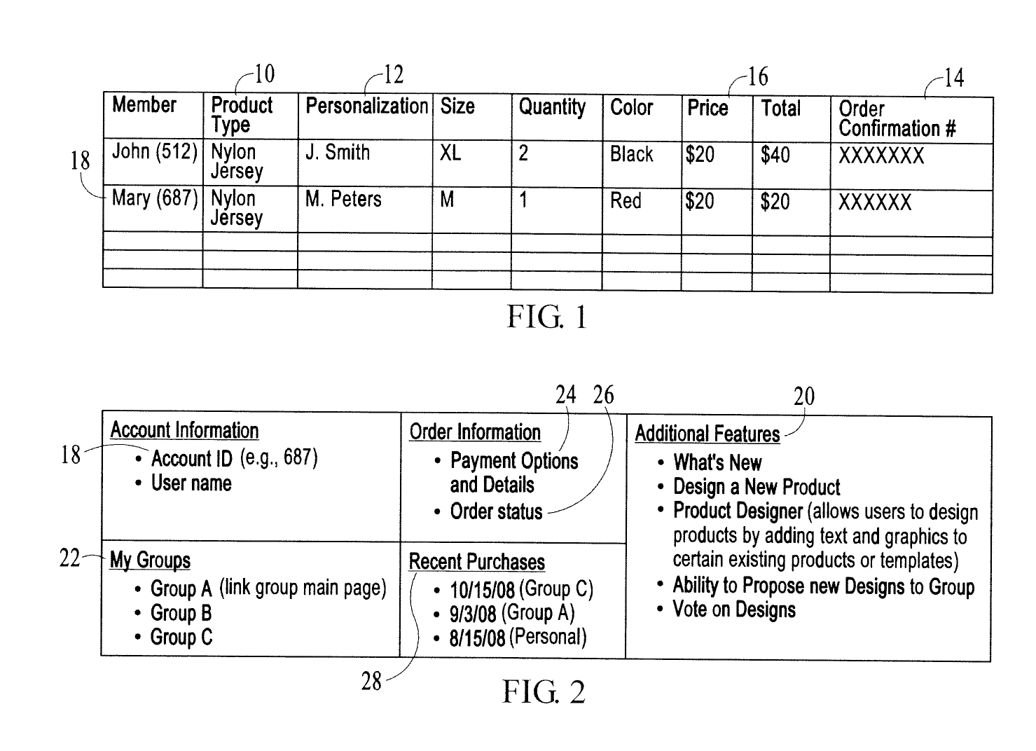

A preferred embodiment of the present invention will now be described with reference to FIGS. 1-4. The invention utilizes a software application, typically resident on a network server, that can be accessed by individuals through an electronic network. For example, the software application can be accessed through the internet by individuals using a web browser. Such a network implementation and its alternatives are well-known to those of ordinary skill in the art.

The process described is particularly suited to groups such as school clubs or athletic teams or other organizations, enabling them to create customized merchandise and offer the merchandise for sale to their members and if desired the online public. Instead of manually taking votes and orders from team members to create team-related merchandise, and instead of expending effort consolidating merchandise orders from disparate clubs to benefit from bulk pricing of the merchandise, this process enables groups such as clubs to design and offer for sale customized merchandise in a collaborative while efficient and cost-saving manner without the time and coordination otherwise necessary to design customized merchandise. Users benefit from bulk pricing, payment coordination, integration of group sponsors and donors, and coordinated distribution of the customized merchandise. An organization simply sets up a group account, allows members to create individual accounts, and facilitates the creation, sale and distribution of customized team merchandise from a single platform.

The present invention allows the organization or group organizer to set up its group account online by creating a unique account identification that permits the organization to log into its group account and access the functionalities within the group account platform. FIGS. 1 and 2 illustrate some possible functionalities. Examples of functionalities the group account may include are:
(a) allowing the group organizer to invite the organization's members to create individual accounts under the group account, or if desired to invite up to an unlimited number of members from the online public to join or access the group account;
(b) allowing organizations to have subgroups, such as teams in a league, where there is a group created for the league, a subgroup for each team or set of affiliated teams, and individual accounts;
(c) allowing the group to create customized merchandise by designing products for its members to purchase or by defining parameters that enable group members to customize various aspects of selected base merchandise 10, for example by adding a member's name to various types of team T-shirts 12;
(d) design controls to allow human or automated review of proposed designs, for example to ensure compliance with league/team rules, to avoid offensive material, to avoid duplication of designs by teams in the same league, to avoid misappropriation of proprietary or copyrighted designs, etc. The human or automated controls/review may be provided by the software application service provider, the organization or subgroup, by individuals authorized to perform such review, or by any combination thereof;
(e) providing an interface for the group organizer to access secured orders 14 made by members who purchase products using various payment and delivery options, including the possibility of offering merchandise at a set price, for example where the quantity of merchandise needed is known, or dynamic, for example where bulk pricing of the base merchandise provides a reduced price for greater quantities of merchandise sold 16;
(f) allowing the choice whether payments are to be centralized for a group or subgroup (e.g. paid by a league or team, by some individuals and not others, or by each individual);
(g) allowing shipment and shipping to be by group, subgroup, or individual, or any combination thereof as elected by those entering orders;
(h) providing a forum, which may be private or public at the organization's choice, for group members to submit, share and vote on designs and otherwise interact with each other and if desired to share designs also to those not within the group account; and
(i) providing the group organizer the opportunity to sell the merchandise in a public or private online marketplace.

In FIG. 1, a T-shirt is chosen for illustration in FIG. 1, but the present invention includes any object that serves as a base product amenable to customization. The platform allows group organizers the possibility of taking advantage of the bulk pricing offered by base merchandise suppliers, to more easily manage payments by facilitating purchasers' payments, aggregating the purchaser's payments for a group account, processing any donations directly through the group account, and permitting any sponsors to apply funds toward group purchases, and to more efficiently distribute customized merchandise to purchasers which may include members or non-members or donors or sponsors. Purchasers may pay in full or in installments, and in either case the platform aggregates and helps coordinate the payments for the group organizer's convenience.

The platform allows individuals to set up individual online accounts to access the individual account interface shown in FIG. 2 using a unique account identification and user name 18 that permits the individual to log-in to his or her account. The platform provides the individual with an easy way to access the various features 20 of the individual account interface, such as a “What's New” section, and features facilitating contribution to product design by voting on designs or by creating new designs using various product design applications or uploading designs, and forums in which the individual may otherwise interact and chat with other individuals. Other functionalities of an individual account interface can include access to the main pages of the individual's various groups 22, purchase of products in various sizes and quantities, specification of various payment and delivery preferences 24, monitoring order status 26, and viewing recent purchases 28. Other features and functionalities that will be apparent to those skilled in the art are also included in the present invention. For example, payments and shipping information can be aggregated by groups, subgroups, or individuals (or any combination thereof), and a selected design may be used on any type of suitable merchandise (e.g. team jerseys, hats, banners, mugs, playing equipment, posters, etc.).

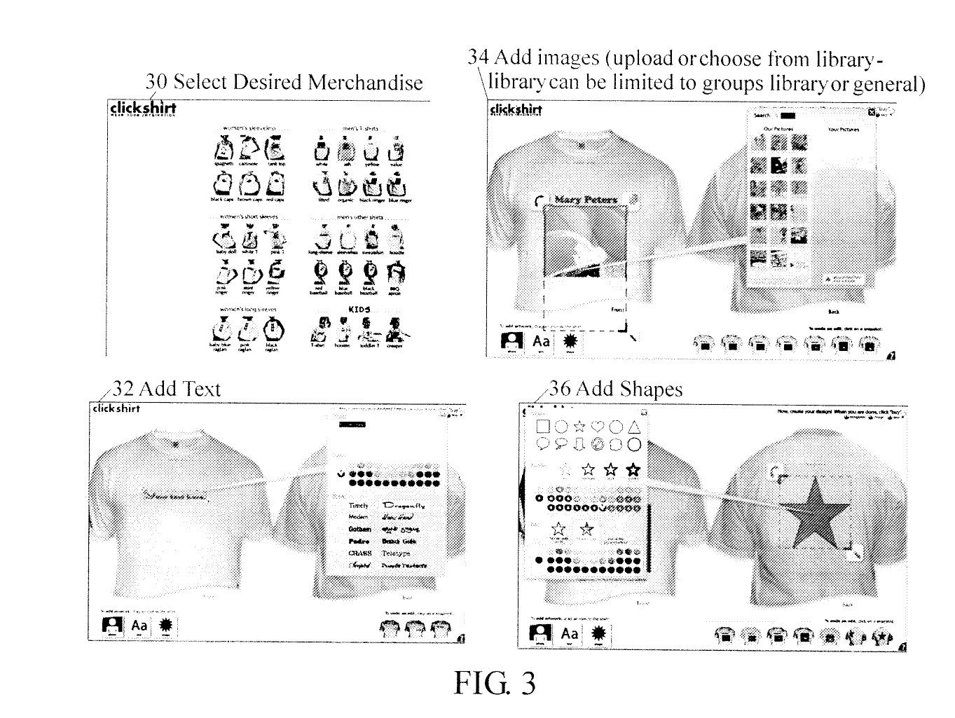

FIG. 3 shows an example of a product design interface functionality, which can be (but is not limited to) an application such as Clickshirt, as shown. Other applications that will be apparent to those skilled in the art are also included in the present invention. In the embodiment shown, the platform first allows an individual to select the desired merchandise to be customized 30. For example, the individual may select T-shirts for women or men, in various colors and sleeve lengths, and in various shapes and sizes. T-shirts 30 are chosen for illustration, but the present invention includes any product available for customization, or if desired by the group organizer, a tailored selection of merchandise that has been pre-determined or partially limited by the group organizer.

The platform also allows the individual to add text to the product easily by typing in the desired text and positioning the text on the merchandise as desired 32. As shown, the individual may customize the color and font of the text as desired 32. The platform allows the individual to add images or designs onto the merchandise 34 by either uploading a desired image or design or by choosing among images from a library, where the library may be one specifically created for or limited to a particular group, or one that is generally available. The platform allows the individual to add various shapes onto the merchandise 36 by selecting desired shapes, selecting desired border and fill for such shapes, and positioning the shapes onto the desired parts of the merchandise.

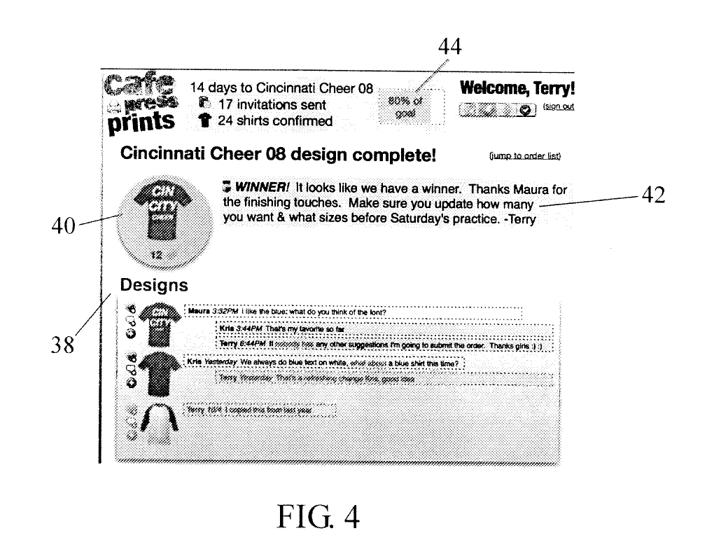

FIG. 4 provides an example of an individual account interface showing group design-sharing and voting functionalities. As referenced in FIG. 2, individuals may interact with other members of a group and propose new designs to vote on or otherwise discuss with one another 20. The individual account interface may show the individuals who propose new designs and discuss or vote on various designs 38. The interface may also indicate to the individual which design gathered the most votes in a design competition 40 and show messages from the group organizer to its members 42 or among members. Where the customized merchandise is being sold as part of a fundraiser for the team or organization, the interface also may show how many shirts have been purchased and what percentage of the fundraising goal has been achieved as a result 44.

The preferred embodiment includes first allowing the group or group organizer to set up a group account with an account identification, then allowing the group or group organizer to select desired parameters of the base product to be customized and desired features to be made available to its individual members. Various members of a limited or unlimited set of individuals are then invited to create individual accounts using unique identification and user names. The present invention provides the individuals with access to various functionalities such as features, forums, groups and applications, as well as to various payment and order information and preferences. As noted above, subgroups of individuals, such as teams in leagues, can be established. The present invention allows individuals to share designs with one another, propose new designs, and vote on various items relating to the group or subgroup. The present invention also allows individuals to create their own products using product design applications such as Clickshirt or upload their own designs. When the customized products are finalized and ready for purchase, the present invention provides an easy platform for purchasers to make payments, arrange for delivery, collect and manage payments, and account for sponsors and donors. Each of these can be aggregated by group or subgroup, or handled individually, or any combination thereof. For example, each individual can pay for his or her portion of an order, or a group organizer can pay for part of a purchase while some individuals pay for parts of the purchase. Similarly, delivery can be direct to individual purchasers or through a centralized address such as that of the group or subgroup organizer, or a combination thereof.

The invention described herein provides a method of creating customized merchandise that a team or organization can easily offer for sale and arrange for payment and delivery to both its members and purchasers in the online marketplace. The process is convenient, cost-saving, and uniquely suited to the group or organization desiring to obtain customized merchandise.

While certain representative embodiments and details have been shown for purposes of illustrating the invention, it will be apparent to those skilled in the art that various changes in the methods and apparatus disclosed herein may be made without departing from the scope of the invention which is defined in the appended claims.

What is claimed is:

1. A method for facilitating the on-line group purchase of customized merchandise, comprising the steps of:
(a) allowing a plurality of individuals access to an on-line platform;
(b) establishing at least one group account that includes a plurality of members of the group;
(c) establishing member accounts for each member electing to establish a member account;
(d) providing at least one customized design for review by a plurality of members in the group;
(e) capturing orders from a plurality of members for application of the design to a selected merchandise item;
(f) obtaining payment for at least part of the orders from at least one payor; and
(g) fulfilling the orders by causing the selected customized merchandise to be created and shipped.

2. The method of claim 1, further comprising the step of establishing a plurality of subgroups in at least one group, wherein the members of each subgroup can be provided with the same or different customized designs.

3. The method of claim 2, wherein each subgroup can have the same or different payors.

4. The method of claim 1, wherein a member can be a member in a plurality of groups or subgroups.

5. The method of claim 1, wherein the amounts due for a plurality of orders are aggregated for payment by one payor.

6. The method of claim 1, wherein the orders from members are aggregated for dynamic pricing.

7. The method of claim 1, wherein the merchandise is shipped to a plurality of addresses designated by members.

8. A method for facilitating the on-line design and group selection of customized merchandise, comprising the steps of:
(a) allowing a plurality of individuals access to an on-line platform;
(b) establishing at least one group account that includes a plurality of members of the group;
(c) establishing member accounts for each member electing to establish a member account;
(d) providing design tools to allow at least one member to create at least one customized design for review by a plurality of members in the group; and
(e) allowing a plurality of members to select a preferred design.

9. The method of claim 8, further comprising the step of providing a screening review before a design is selected.

10. The method of claim 9, wherein the screening review is automated and reviews the design to ensure compliance with design controls selected from the group consisting of league rules, team rules, avoidance of offensive material, duplication of designs, and avoidance of misappropriated designs.

11. The method of claim 8, further comprising the step of establishing a plurality of subgroups in at least one group, wherein the members of each subgroup can be provided with the same or different customized designs.

12. The method of claim 8, wherein a member can be a member in a plurality of groups or subgroups.

13. A method for facilitating the on-line group purchase of customized merchandise, comprising the steps of:
(a) allowing a plurality of individuals access to an on-line platform;
(b) establishing at least one group account that includes a plurality of members of the group;
(c) establishing member accounts for each member electing to establish a member account;
(d) providing design tools to allow at least one member to create at least one customized design for review by a plurality of members in the group;
(e) allowing a plurality of members to select a preferred design;
(f) capturing orders from a plurality of members for application of the design to a selected merchandise item;
(g) obtaining payment for at least part of the orders from at least one payor; and
(h) fulfilling the orders by causing the selected customized merchandise to be created and shipped.

14. The method of claim 13, further comprising the step of establishing a plurality of subgroups in at least one group, wherein the members of each subgroup can be provided with the same or different customized designs.

15. The method of claim 14, wherein each subgroup can have the same or different payors.

16. The method of claim 13, wherein a member can be a member in a plurality of groups or subgroups.

17. The method of claim 13, wherein the amounts due for a plurality of orders are aggregated for payment by one payor.

18. The method of claim 13, wherein the orders from members are aggregated for dynamic pricing.

19. The method of claim 13, wherein the merchandise is shipped to a plurality of addresses designated by members.

20. The method of claim 13, further comprising the step of providing a screening review before a design is selected.

21. The method of claim 20, wherein the screening review is automated and reviews the design to ensure compliance with design controls selected from the group consisting of group rules, subgroup rules, avoidance of offensive material, duplication of designs, and avoidance of misappropriated designs.
